(19) United States
(12) Patent Application Publication
(10) Pub. No.: US 2015/0095221 A1
(43) Pub. Date: Apr. 2, 2015

(54) Systems and Methods for Activating Electronic Bill Presentment

(71) Applicant: Fiserv, Inc., Brookfield, WI (US)

(72) Inventors: Ralph D. Au, Powell, OH (US); Lori Irene Stepp, Decatur, GA (US); Todd Alan Weiss, Atlanta, GA (US)

(21) Appl. No.: 14/561,902

(22) Filed: Dec. 5, 2014

Related U.S. Application Data
(63) Continuation of application No. 13/221,070, filed on Aug. 30, 2011.

(51) Int. Cl. G06Q 20/10

(52) U.S. Cl. CPC G06Q 20/102
USPC 705/40

(57) ABSTRACT

Systems and methods for activating electronic bill presentment are provided. Payment history information associated with one or more payments made on behalf of a payor to a biller may be identified. Additionally, at least one biller-specified condition associated with automatic activation of the electronic presentment of bills of the biller for the payor may be identified. Based at least in part upon an analysis of the payment history information, a determination may be made that the at least one biller-specified condition has been satisfied, and the automatic activation of the electronic presentment of bills of biller for the payor may be facilitated.

### CROSS-REFERENCE TO RELATED APPLICATION(S)

This application is a continuation of U.S. Nonprovisional application Ser. No. 13/221,070 filed Aug. 30, 2011, the entire disclosure of which is hereby incorporated by reference.

### FIELD OF THE INVENTION

Aspects of the invention relate generally to electronic bill presentment, and more particularly, to the automatic activation of electronic bill presentment.

### BACKGROUND OF THE INVENTION

Several available services facilitate the electronic presentment of bills to biller customers. As one example, a third-party service provider facilitates the electronic presentment of bills on behalf of a plurality of billers. As another example, a third-party service provider hosts a similar service for an individual biller. Finally, a biller may host biller-direct electronic presentment of bills for its own customers. Each of these alternatives may be associated with electronic bill payment services, offered by the same service provider or biller, or by a different entity. Electronic bill payment through a third-party service provider is often available for more than just electronically presented bills. Although many consumers take advantage of available electronic bill payment services, fewer consumers have activated the electronic presentment of bills. However, electronic bill presentment services can often be more convenient for both customers and billers.

### BRIEF DESCRIPTION OF THE DRAWINGS

Reference will now be made to the accompanying drawings, which are not necessarily drawn to scale, and wherein:

FIG. 1 is a block diagram of an example system that facilitates the activation of electronic bill presentment services, according to an example embodiment of the invention.

FIG. 2 is a flow diagram of an example method for facilitating the activation of electronic bill presentment services, according to an example embodiment of the invention.

FIG. 3 is a flow diagram of an example method for determining whether one or more biller-specified conditions have been satisfied for automatic activation of electronic bill presentment, according to an example embodiment of the invention.

FIG. 4 is a flow diagram of an example method for automatically activating electronic bill presentment, according to an example embodiment of the invention.

FIG. 5 is a flow diagram of an example method for managing electronic bill presentment, according to an example embodiment of the invention.

### DETAILED DESCRIPTION OF THE INVENTION

The invention will now be described more fully hereinafter with reference to the accompanying drawings, in which example embodiments of the invention are shown. This invention may, however, be embodied in many different forms and should not be construed as limited to the example embodiments set forth herein; rather, these example embodiments are provided so that this disclosure will be thorough and complete, and will fully convey the scope of the invention to those of ordinary skill in the art. Like numbers refer to like elements throughout.

Embodiments of the invention may provide systems and methods for facilitating the activation of electronic bill presentment. In certain embodiments of the invention, payment history information between a bill payment customer, also referred to as a payor or consumer, whether the bill payment customer is an individual or a business, and a biller may be evaluated in order to determine whether an electronic bill presentment service may be automatically activated in order to electronically present bills of the biller to the payor or consumer. For example, information associated with payments made on behalf of the payor to the biller by a third-party payment service provider and/or information associated with payments made directly to the biller by the payor may be obtained. Once payment history information has been obtained, at least a portion of the payment history information may be evaluated in order to determine whether one or more biller-specified conditions associated with the automatic activation of electronic bill presentment have been satisfied. Following a determination that the one or more biller-specified conditions have been satisfied, electronic bill presentment may be activated for the payor.

As desired in various embodiments, a wide variety of different types of biller-specified conditions may be evaluated. Additionally, a wide variety of different payment history factors may be evaluated in conjunction with biller-specified conditions, including but not limited to, a volume of past payments, a frequency of past payments, one or more amounts associated with past payments, and/or the success of effecting and/or posting one or more past payments. Additionally, in certain embodiments, at least one condition associated with another entity, such as the payor, a service provider that facilitates bill payment and presentment, a sponsor of the payor, or a financial institution of the payor, may be identified and evaluated in order to determine whether electronic bill presentment will be automatically activated. Indeed, a wide variety of different parameters and/or evaluation techniques may be utilized. A few example parameters and evaluation techniques are described in greater detail below.

As desired, a wide variety of suitable techniques may be utilized to facilitate the automatic activation of electronic bill presentment. In certain embodiments, such as embodiments in which a biller system provides electronic bill presentment and payment (“EBPP”) services, the biller system may automatically activate electronic bill presentment. In other embodiments, such as embodiments in which a third-party service provider facilitates EBPP services, a request to activate electronic bill presentment for the payor may be communicated to a biller system. For example, a request may be communicated in real-time, in near real-time, in a batch process, and/or in accordance with some other preferred communication method. The biller system may process the request in order to activate electronic bill presentment and, in certain embodiments, an indication that electronic bill presentment has been activated may be returned to the requesting entity.

Additionally, in certain embodiments of the invention, electronic presentment of bills may be activated for a predetermined period of time, such as a trial period. During the predetermined period of time, a wide variety of different types of payor input may be received and processed. For example, a payor request to opt out of electronic bill presentment may be received, and the electronic presentment of bills may be terminated as a result of the opt out request. As another example, a payor acceptance of terms and conditions associated with suppressing of the delivery of paper billing statements may be received, and the delivery of paper billing statements from the biller to the payor may be suppressed based at least in part upon the acceptance of the terms and conditions.

I. System Overview

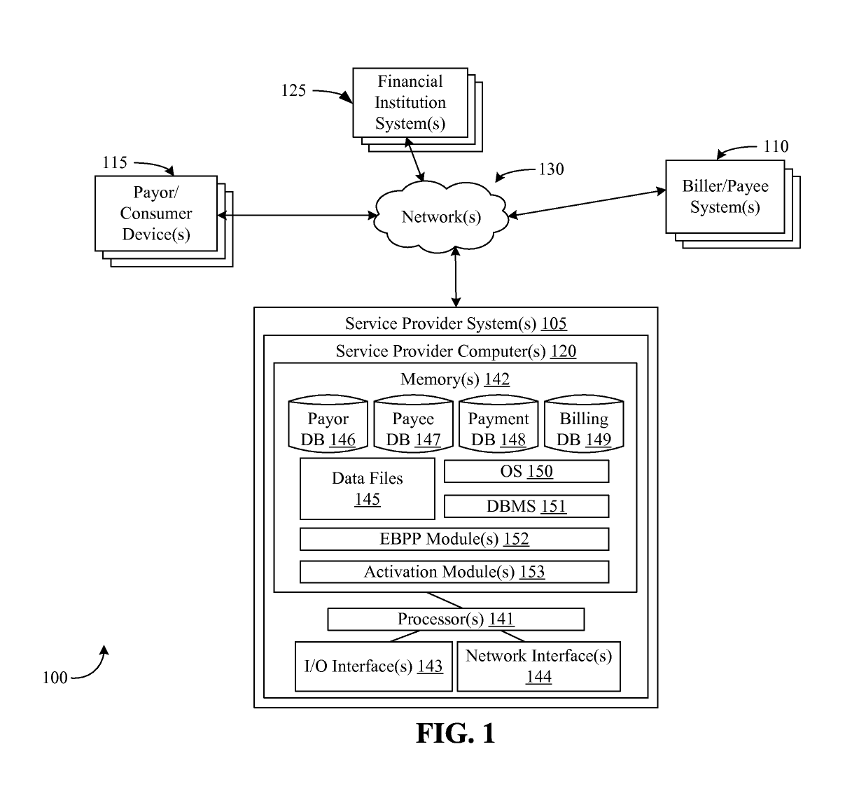

FIG. 1 illustrates an overview of an example system 100 that facilitates the activation of electronic bill presentment services, according to an example embodiment of the invention. Although various computing devices and/or computers are illustrated in FIG. 1, it is appreciated that corresponding entities and/or individuals are associated with each of the computers illustrated. Additionally, as desired, less than or more than the devices illustrated in FIG. 1 may be utilized. Further, in certain embodiments, functionality described in association with a first device may be performed by a second device.

With reference to FIG. 1, one or more service provider systems 105, biller or payee systems 110, and/or payor or consumer devices 115 may be provided. The one or more service provider systems 105 may be associated with one or more service provider computers 120. The service provider systems 105 may provide electronic bill presentment and payment (“EBPP”) services. The biller systems 110 may be respective systems associated with any number of billing entities and/or other payees. With continued reference to FIG. 1, one or more financial institution systems 125 may be provided. Each of the financial institution systems 125 may include any number of financial institution computers. Additionally, each of the financial institution systems 125 may be associated with a financial institution, such as but not limited to, a bank, a thrift entity, a credit union, or a brokerage entity. Each payor device 115 may be a suitable processor-driven device (e.g., a computer, a mobile device, etc.) associated with a payor. Additionally, each payor device 115 may facilitate payor access to one or more services provided by the service provider system(s) 105, the biller system(s) 110, and/or the financial institution system(s) 125. For simplicity, the systems, computers, devices, and/or entities illustrated in FIG. 1 may be referenced in the singular, but it is appreciated that the same description applies to embodiments including multiple systems, computers, devices and/or entities. Similarly, for each of the computers described herein, it is appreciated that the computer may include any number of suitable components and/or functionality.

As shown in FIG. 1, one or more of the service provider system(s) 105, the biller system(s) 110, the payor devices 115, and the financial institution system(s) 125 may be in communication with each other via any number of suitable networks 130, which, as described below, can include one or more separate or shared private and/or public networks, including the Internet or a publicly switched telephone network.

As desired in certain embodiments, the service provider system(s) 105 may be associated with one or more service providers. For example, a service provider systems 105 may be associated with a third-party service provider that provides EBPP services to payors or consumers with respect to various billers. In certain embodiments, EBPP services may be directly provided to payors that are direct customers of one or more service provider system(s) 105. In other embodiments, a service provider system 105 may operate to provide services to customers of one or more other entities. For example, a financial institution may contract with a service provider associated with the service provider system 105 to provide EBPP services to customers of the financial institution. A customer of the financial institution may access online banking services provided by the financial institution system 125 (or a service provider hosted system). Based upon a request to access EBPP services, the customer may be redirected by the financial institution system 125 to the service provider system 105. In certain embodiments, the redirection may be transparent to the customer. In other words, it may appear to the customer that services are continuing to be provided by the financial institution system 125. As desired, the EBPP services provided to the customer may be branded in accordance with various preferences of the financial institution. In yet other embodiments, functionality described for the service provider system 105 may be performed by a biller system 110. In other words, a payor may utilize a payor device 115 to directly access a biller system 110 for EBPP services.

With reference to the service provider system 105 of FIG. 1, the service provider system 105 may include any number of service provider computers 120. A service provider computer 120 may be any suitable processor-driven device that facilitates the provision of EBPP services to one or more payors or consumers, such as a server computer, a mainframe computer, one or more networked computers, a desktop computer, a personal computer, a digital assistant, a personal digital assistant, a mobile device, a digital tablet, an Internet appliance, an application-specific circuit, a microcontroller, a minicomputer, or any other processor-based device. The execution of suitable computer-implemented instructions by the service provider computer 120 may form a special purpose computer or other particular machine that is operable to facilitate the provision of one or more EBPP services. Additionally, in accordance with an aspect of the invention, a special purpose computer or other particular machine may be formed that is operable to facilitate automatic activation of electronic presentment of bills of a biller to a payor or consumer. Although a single service provider computer 120 is described herein, the operations and/or control of the service provider computer 120 may be distributed among any number of computers and/or processing components.

In addition to having one or more processors 141, the service provider computer 120 may include one or more memory devices 142, one or more input/output (“I/O”) interfaces 143, and one or more network interfaces 144. The memory devices 142 may be any suitable memory devices, for example, caches, read-only memory devices, random access memory devices, magnetic storage devices, removable storage devices, etc. Additionally, any number of logical data storage constructs may be stored as desired within the memory devices 142, such as any number of suitable databases. The memory devices 142 may store a wide variety of data, such as data files 145, a payor or customer database 146, a payee database 147, a payment database 148, and/or a billing database 149. Additionally, the memory devices 142 may store executable instructions and/or various program modules utilized by the service provider computer 120, for example, an operating system (“OS”) 150, a database management system (“DBMS”) 151, one or more EBPP modules 152, and/or an activation module 153.

The data files 145 may include any suitable data that facilitates the operations of the service provider computer 120, the provision of EBPP services to one or more payors, and/or the automatic activation of electronic bill presentment services. For example, the data files 145 may include data associated with one or more EBPP services, data associated with identifying billers and/or payees for consumer payors, data associated with identifying payment history information, data associated with identifying conditions and/or for the automatic activation of electronic bill presentment, data associated with facilitating the automatic activation of electronic bill presentment, and/or data that facilitates interaction with any number of other systems and/or components (e.g., the biller systems 110, a financial institution system 125, etc.). The payor database 146 (also referred to as a consumer, customer, or subscriber database) may include data associated with one or more payors using services of the service provider system 105. For example, the payor database 146 may include payor contact information, information associated with payor preferences for providing EBPP services, information associated with payor preferences for activating electronic bill presentment, and/or information associated with payees and/or billers for various payors. The payee database (also referred to as a biller database) 147 may include data associated with one or more billers or payees to whom the service provider system 105 submits payments on behalf of payors. For example, the payee database 147 may include biller contact information, biller-specified conditions for automatically activating electronic bill presentment, biller preferences associated with the activation of electronic bill presentment, information associated with remitting payments to the billers, etc.

The payment database 148 may include a wide variety of historical payments information associated with payments made by payors or consumers to various billers. In certain embodiments, the historical payments information may include information associated with payments made by the service provider system 105 on behalf of payors. Additionally, as desired, the historical payments information may include information associated with payments made by payors directly to various billers. For example, the service provider computer 120 may obtain payment history information from the biller systems 110, and at least a portion of the obtained payment history information may be stored. The billing database 149 may include billing information received from the biller systems 110 for presentment to the payors. Examples of billing information include, but are not limited to, copies of complete bills, bill summary information, and/or detailed billing information. Any number of databases may be utilized as desired in various embodiments. Additionally, multiple databases may be utilized to store similar information. The databases described with reference to FIG. 1 are provided by way of example only.

The OS 150 may be a suitable software module that controls the general operation of the service provider computer 120. The OS 150 may also facilitate the execution of other software modules by the one or more processors 141, for example, the DBMS 151, the EBPP module(s) 152, and/or the activation module(s) 153. The OS 150 may be, but is not limited to, Microsoft Windows®, Apple OSX™, Linux, Unix, or a mainframe operating system. The DBMS 151 may be a suitable software module or application that facilitates the management of one or more databases, such as the payor database 146, the payee database 147, the payment database 148, and/or the billing database 149. The DBMS 151 may facilitate the access of stored information included in the databases and/or the writing of information to the databases. Additionally, in certain embodiments, the DBMS 151 may facilitate the access of information stored in one or more external databases.

Any number of EBPP modules 152 may be provided as desired in various embodiments of the invention. The EBPP modules 152 may be suitable software modules that facilitate a wide variety of different bill payment and/or bill presentment services. For example, an EBPP module 152 may facilitate the receipt of payment requests (e.g., bill payment requests) from various payors and the direction of payments (e.g., electronic payments, paper payments, etc.) to various billers and/or payees on behalf of the payors. As another example, an EBPP module 152 may facilitate the receipt of electronic billing information from a biller system 110 associated with the biller, the processing of the billing information, and/or the presentment of at least a portion of the billing information to customers of the biller that are also subscribers or customers (i.e., payors) of the service provider.

The activation module(s) 153 may be any number of suitable software modules that facilitate the automatic activation of electronic bill presentment. For example, an activation module 153 may identify a situation in which electronic bill presentment of bills of a biller for a particular payor should be automatically activated. In certain embodiments, the activation module 153 may facilitate the automatic activation of a electronic bill presentment for a payor with respect to a biller based upon an evaluation of past payments made by the payor to the biller. For example, information associated with payments made on behalf of the payor to the biller by the service provider system 105 may be accessed. As another example, information associated with payments made directly to the biller by the payor may be obtained. Once payment history information has been accessed and/or obtained, at least a portion of the payment history information may be evaluated in order to determine whether one or more conditions associated with the automatic activation of electronic bill presentment have been satisfied. In the event that automatic activation conditions have been satisfied, the activation module 153 may facilitate the automatic activation of electronic bill presentment.

A wide variety of different types of conditions associated with automatic activation of electronic bill presentment may be evaluated by the activation module 153 as desired in various embodiments of the invention. These conditions may include conditions associated with the service provider, billers, payors, financial institutions, and/or other entities. According to an aspect of the invention, at least one biller-specified condition may be evaluated in order to determine whether the electronic presentment of bills for the biller will be activated for a particular payor or consumer. In other words, a biller may specify one or more conditions that will be utilized to determine whether to activate electronic bill presentment for a payor. A wide variety of different types of biller-specified conditions may be utilized as desired in various embodiments, including but not limited to, a volume of past payments (e.g., a threshold number of payments made to the biller, potentially within a predetermined period of time), a frequency of past payments, one or more amounts associated with past payments (e.g., a threshold average payment amount, a threshold total payment amount, a minimum payment amount, etc.), and/or the success of effecting or posting one or more past payments. Following the identification of one or more biller-specified conditions, the activation module 153 may evaluate the payment history information utilizing the biller-specified conditions. In this regard, the activation module 153 may determine whether the biller-specified conditions have been satisfied.

Additionally, in certain embodiments, at least one condition associated with another entity, such as the payor, a service provider that facilitates bill payment and presentment, a sponsor of the payor, or a financial institution of the payor, may be identified and evaluated by the activation module 153 in order to determine whether electronic bill presentment will be automatically activated. For example, the activation module 153 may determine whether automatic activation is supported for the payor, a designated payor device 115, and/or the financial institution. As another example, the activation module 153 may evaluate a payor profile in order to determine whether a payor has consented to automatic activation. As another example, the payor, financial institution, service provider, and/or another entity may specify one or more payment history conditions to be evaluated. Indeed, a wide variety of different parameters and/or evaluation techniques may be utilized as desired.

If the activation module 153 determines that one or more conditions for automatic activation have been satisfied, then a wide variety of suitable techniques may be utilized by the activation module 153 to facilitate the automatic activation of electronic bill presentment for the biller and payor. In certain embodiments, such as embodiments in which a third-party service provider system 105 facilitates EBPP services, a request to activate electronic bill presentment for the payor may be generated by the activation module 153 and communicated to a biller system 110. For example, a request may be communicated in real-time, in near real-time, in a batch process, and/or in accordance with some other preferred communication method. The biller system 110 may process the request in order to activate electronic bill presentment and, in certain embodiments, an indication that electronic bill presentment has been activated may be returned to the service provider computer 120 and/or the activation module 153. In other embodiments, such as embodiments in which a biller system provides EBPP services directly to the payor, the activation module 153 may be associated with a biller system 110, and the activation module 153 may automatically activate electronic bill presentment.

Additionally, in certain embodiments of the invention, the electronic presentment of bills may be activated for a predetermined period of time, such as a trial period. During the predetermined period of time, a wide variety of different types of payor or consumer input may be received and processed by the activation module 153. For example, a payor request to opt out of electronic bill presentment may be received, and the activation module 153 may facilitate the termination of the electronic presentment of bills as a result of the opt out request. As another example, a payor acceptance of the terms and conditions associated with the suppression of the delivery of paper billing statements may be received, and the delivery of paper billing statements from the biller to the payor may be suppressed by the activation module 153 based at least in part upon the acceptance of the terms and conditions.

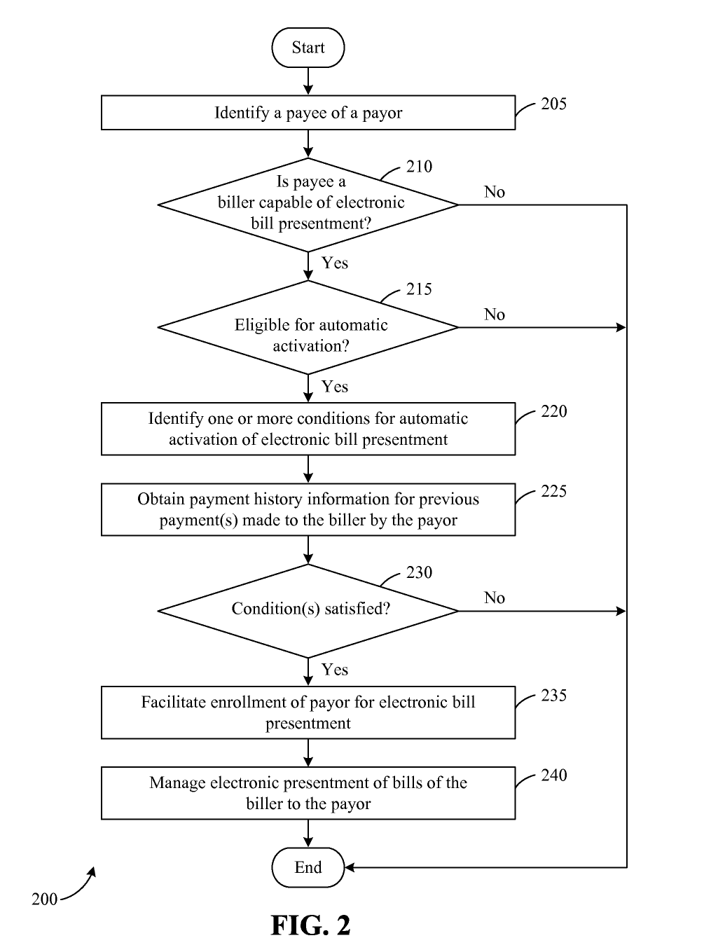

One example of the operations that may be performed by the activation module 153 is described in greater detail below with reference to FIGS. 2-4.

As desired, one or more host module(s) may also be associated with the service provider computer 120. Each host module may facilitate interaction between the service provider computer 120 and any number of payors or consumers. For example, a payor may utilize a payor device 115 to access a host module and request EBPP services. The host module(s) may include any number of suitable host modules, such as Web servers, email servers, and/or short message service (“SMS”) processing applications, including various dedicated applications, that facilitate interaction with any number of payor devices 115.

With continued reference to the service provider computer 120, the one or more I/O interfaces 143 may facilitate communication between the service provider computer 120 and one or more input/output devices, for example, one or more user interface devices, such as a display, keypad, mouse, pointing device, control panel, touch screen display, remote control, microphone, speaker, etc., that facilitate user interaction with the service provider computer 120. The I/O devices may be utilized, for example, by operational support personnel and/or programmers to enter information into and/or to receive information from the service provider computer 120 and/or to maintain the service provider computer 120. The one or more network interfaces 144 may facilitate connection of the service provider computer 120 to one or more suitable networks, for example, the networks 130 illustrated in FIG. 1. In this regard, the service provider computer 120 may receive and/or communicate information to other components of the system 100, such as the biller systems 110, the payor devices 115, and/or the financial institution systems 125.

With continued reference to FIG. 1, any number of biller or payee systems 110 may be provided. Each biller system 110 may be associated with or maintained by a billing entity, such as a utility provider, mortgage company, or other biller. Alternatively, a biller system 110 may be associated with and maintained by another biller service provider. Each biller system 110 may include any number of biller system computers, which may include similar components to those described above for the service provider computer 120. In certain embodiments, a biller system 110 may provide electronic billing information to the service provider computer 120. Additionally, the biller system 110 may receive and process payment information communicated to the biller system 110 by the service provider computer 120. The biller system 110 may also receive and process activation requests output by the service provider computer 120. For example, the biller system 110 may receive a request to activate electronic presentment of bills for a payor. The request may include identification information for the payor (e.g., a payor identifier, a payor name, an account number of the payor with the biller, etc.). The biller system 110 may process the request in order to activate the electronic presentment of billing information associated with bills of the biller for the payor. For example, billing information may be electronically provided by the biller system 110 to the service provider computer 120 for presentation to the payor by the EBPP modules 152.

In other embodiments, the biller system 110 may host one or more EBPP services that are provided to customers of the biller. For example, the biller system 110 may provide billing information directly to payor devices 115, and the biller system 110 may process payment requests received directly from the payor devices 115. Additionally, the biller system 110 may identify situations in which electronic presentment of bills will be automatically activated, and the biller system 110 may facilitate the automatic activation of electronic bill presentment.

With continued reference to FIG. 1, any number of payor devices 115 or consumer devices may be provided. A payor device 115 may be a suitable processor-driven device, such as a personal computer or a mobile device, that facilitates access of one or more services via the networks 130. As such, a payor device 115 may include any number of processors, memory devices, I/O interfaces, and/or network interfaces. The processors may access computer-executable instructions and/or programming modules (e.g., a Web browser) that facilitate operations of the user device in accordance with various embodiments of the invention. In certain embodiments, a payor may utilize a payor device 115 to access one or more Web sites hosted by other components of the system 100, such as the service provider computers 120, the financial institution systems 125, and/or the biller systems 110. For example, the payor may access one or more Web sites associated with various EBPP services. Additionally, the payor may provide user commands, requests, and/or information to one or more hosted services via the payor device 115. The payor may also receive any number of presentations, messages, and/or alerts via the payor device 115.

Additionally, any number of financial institution systems 125 may be provided. Each financial institution system 125 may be associated with or maintained by a financial institution, such as a bank, a thrift entity, a credit union, or a brokerage entity. Alternatively, a financial institution system 125 may be associated with a service provider that provides services, such as online banking services, on behalf of one or more financial institutions. Each financial institution system 125 may include any number of financial institution computers, which may include similar components to those described above for the service provider computer 120. In certain embodiments, a financial institution system 125 may redirect payors requesting EBPP services to a service provider system 105 that provides these services.

The networks 130 may include any telecommunication and/or data networks, whether public, private, or a combination thereof, including but not limited to, a local area network, a wide area network, an intranet, the Internet, intermediate handheld data transfer devices, public switched telephone networks, and/or any combination thereof and may be wired and/or wireless.

Those of ordinary skill in the art will appreciate that the system 100 shown in and described with respect to FIG. 1 is provided by way of example only. Numerous other operating environments, system architectures, and device configurations are possible. Other system embodiments can include fewer or greater numbers of components and may incorporate some or all of the functionality described with respect to the system components shown in FIG. 1. Accordingly, embodiments of the invention should not be construed as being limited to any particular operating environment, system architecture, or device configuration.

II. Operational Overview

FIG. 2 is a flow diagram of an example method 200 for facilitating the activation of electronic bill presentment services, according to an example embodiment of the invention. In certain embodiments, the operations of the method 200 may be performed by one or more service provider computers associated with a service provider, such as the service provider computers 120 associated with the service provider system 105 of FIG. 1. The method 200 may begin at block 205.

At block 205, a payee of a payor (or consumer) may be identified. For example, a payor that is a subscriber to electronic and/or paper payment services provided by a service provider system 105 may be identified. A designated payee of the payor, such as a payee included in a payor payee list, may then be identified. Once a payee of the payor has been identified, operations may continue at block 210, and a determination may be made as to whether the identified payee is a biller capable of electronic bill presentment. A wide variety of suitable methods and/or techniques may be utilized as desired to determine whether the identified payee is a biller capable of electronic bill presentment. For example, if the payee is a “managed” payee of the service provider (e.g., a biller having an established remittance relationship with the service provider), then stored information associated with the payee may be examined in order to determine whether the payee is capable of electronic bill presentment. As another example, if the payee has not yet been mapped to a “managed” payee, then a suitable process may be executed in order to determine whether information associated with a managed payee corresponding to the payee is stored in a suitable merchant database. A determination may then be made as to whether the payee is capable of electronic bill presentment.

If it is determined at block 210 that the payee is not a biller that is capable of electronic bill presentment, then operations may end. If, however, it is determined at block 210 that the payee is a biller that is capable of electronic bill presentment, then operations may continue at block 215. At block 215, a determination may be made as to whether the payor and biller combination is eligible for automatic activation of electronic bill presentment. As desired, the capabilities and/or preferences of a wide variety of different entities may be evaluated in order to determine eligibility for automatic activation. For example, a determination may be made as to whether the biller, the payor, and/or a sponsor of the payor (e.g., financial institution, etc.) is eligible for and/or supports the automatic activation of electronic bill presentment. If it is determined at block 215 that the payor and biller combination is not eligible for automatic activation of electronic bill presentment, then operations may end. If, however, it is determined at block 215 that the payor and biller combination is eligible for automatic activation of electronic bill presentment, then operations may continue at block 220.

At block 220, one or more conditions associated with the automatic activation of electronic bill presentment for the payor from the biller may be identified. These conditions may include conditions associated with a wide variety of different entities, such as the biller, the payor, a sponsor, and/or a service provider. According to an aspect of the invention, at least one biller-specified condition may be identified. The biller-specified condition may be a condition associated with the biller that sets forth a threshold or other predetermined condition to be satisfied prior to the automatic activation of electronic bill presentment. A wide variety of different types of biller-specified conditions may be utilized as desired in various embodiments, including but not limited to, a volume and/or frequency of past payments (e.g., a threshold number of payments made to the biller, potentially within a predetermined period of time), one or more amounts associated with past payments (e.g., a threshold average payment amount, a threshold total payment amount, a minimum payment amount, etc.), and/or the success of effecting or posting one or more past payments. In addition to identifying one or more biller-specified conditions, one or more conditions associated with other entities (e.g., the payor, the service provider, a financial institution, another sponsor, etc.) may also be identified. In certain embodiments, these conditions may include similar parameters as those of the described biller-specified conditions.

At block 225, payment history information associated with one or more previous payments made to the biller by the payor may be obtained. In certain embodiments, payment history information may be accessed from memory. For example, a service provider may access stored information associated with previous payments made to a biller on behalf of the payor. Additionally or alternatively, payment history information may be obtained from one or more other entities, such as the biller, other service providers, and/or from various financial institutions. For example, a request for payment history information may be communicated to the biller, and payment history information may be received in response to the request. The payment history information may include information associated with a wide variety of different payments, such as payments made to the biller by a service provider on behalf of the payor and/or payments made directly to the biller by a payor.

At block 230, a determination may be made as to whether the identified one or more conditions have been satisfied. In other words, a determination may be made as to whether various thresholds and/or other requirements specified by the conditions have been met. If it is determined at block 230 that the one or more conditions have not been satisfied, then operations may end. If, however, it is determined at block 230 that the one or more conditions have been satisfied, then operations may continue at block 235.

At block 235, enrollment of the payor for electronic presentment of bills of the biller may be facilitated. The delivery and/or presentment of bills of the biller to the payor may then be managed at block 240. A wide variety of suitable methods and/or techniques may be utilized as desired to facilitate the enrollment and/or management of electronic bill delivery and/or presentment for the payor and the biller. For example, with respect to enrollment, a service provider system 105 may communicate an enrollment or activation request to a suitable biller system 110, and the biller system 110 may process the request to activate electronic bill presentment for the payor. As desired, a notification of the activation may be returned to the service provider system 105 by the biller system 110. As another example of enrollment and/or activation, a biller system 110 may evaluate payment history information and/or activation parameters, and the biller system 110 may activate electronic bill presentment for the payor.

Once electronic presentment of bills of a biller has been activated for a payor, billing information may be provided to the payor in electronic format. For example, a biller system 110 may communicate billing information for the payor to a service provider system 105, and the service provider system 105 may format the billing information for communication and/or presentation to the payor. In certain embodiments, the electronic presentment of bills may be activated for a predetermined period of time, such as a trial period of time. For example, a trial period of one month, three months, or six months may be utilized. In certain embodiments, paper bills may continue to be delivered to the payor during the trial period. In other words, a payor or consumer may receive both paper bills and electronic billing information associated with the paper bills of the biller.

In certain embodiments, during the predetermined period of time, a determination may be made as to whether the electronic presentment of bills should be continued and/or made permanent. Additionally, a determination may be made as to whether the delivery of paper bills may be suppressed or discontinued. A wide variety of suitable methods and/or techniques may be utilized as desired to facilitate these determinations. For example, a payor request to opt out of electronic bill presentment may be received and processed. Based at least in part upon the request, the electronic presentment of bills of the biller to the payor may be discontinued. For example, a service provider system 105 may request that a biller system 110 discontinue electronic bill presentment for the payor. As another example, a biller system 110 may process a payor request and discontinue electronic bill presentment.

In a similar manner, a payor request or approval to continue electronic bill presentment may be received and processed. In certain embodiments, the processing of a payor request or approval to continue electronic bill presentment may also result in suppression of paper delivery of bills to the payor. For example, one or more terms and conditions associated with the suppression of paper bill delivery may be presented to the payor, and a payor acceptance of the terms and conditions may be received. Following the receipt of the payor acceptance, paper delivery of bills may be suppressed. For example, a service provider system 105 may communicate a message to a biller system 110 indicating that paper delivery should be suppressed for the payor. As another example, a biller system 110 may receive the payor acceptance, and the biller system 110 may process the payor acceptance in order to suppress paper delivery of bills for the payor.

The method 200 may end following either block 210, 215, 230, or 240.

The operations described above with reference to FIG. 2 may be performed at any point in time and/or be based upon the occurrence of any number of conditions. For example, the payors of a payee may be periodically evaluated (e.g., evaluated once a month, once every six months, etc.) in order to determine whether electronic bill presentment may be activated for any of the payees. As another example, one or more payors of a payee may be evaluated based upon the identification of a payment event, a log-in event by the payor, a log-out event by the payor, and/or any other suitable event.

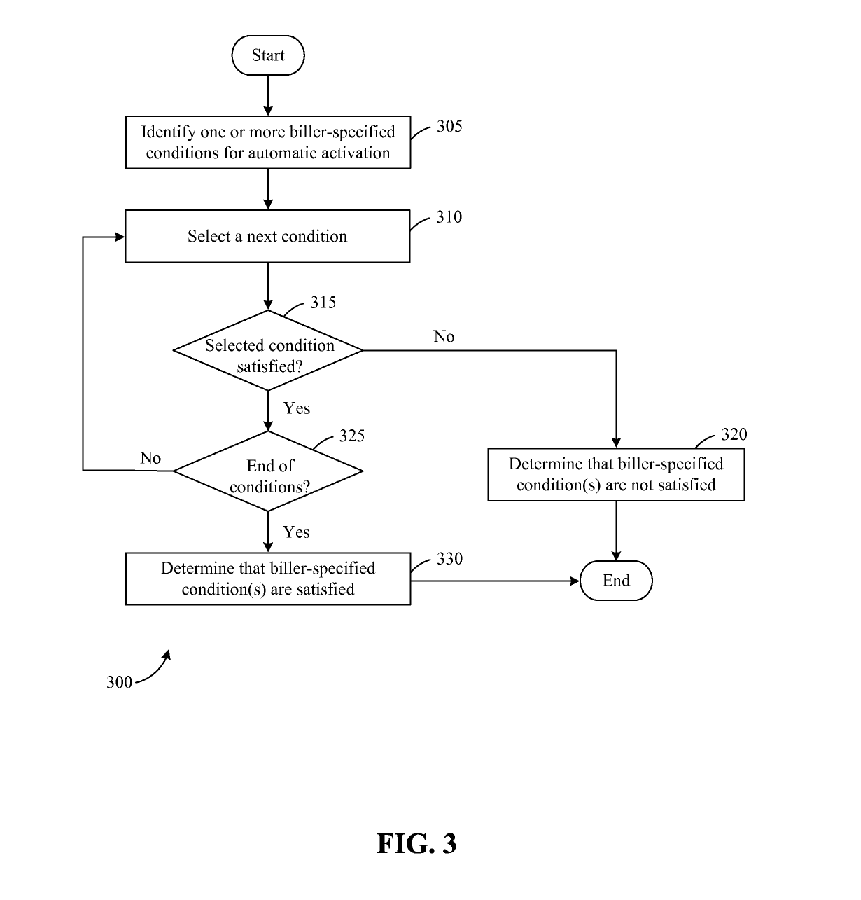

FIG. 3 is a flow diagram of an example method 300 for determining whether one or more biller-specified conditions have been satisfied for automatic activation of electronic bill presentment, according to an example embodiment of the invention. The operations included in the method 300 may be one example of the operations performed at blocks 225 and 230 of the method 200 illustrated in FIG. 2. As such, the operations of the method 300 may be performed by one or more service provider computers associated with a service provider, such as the service provider computers 120 associated with the service provider system 105 of FIG. 1. The method 300 may begin at block 305.

At block 305, one or more biller-specified conditions associated with automatic activation may be identified. The biller-specified conditions may include a wide variety of parameters and/or thresholds to be satisfied in order to activate electronic presentment of bills for a particular payor that is a customer of the biller. In certain embodiments, these conditions may include conditions associated with one or more previous payments made by the payor to the biller. For example, the biller-specified conditions may include threshold conditions associated with a volume of previous payments made to the biller by the payor and/or on behalf of the payor, one or more amounts associated with previous payments, and/or various success criteria (e.g., payment effecting or posting success, etc.) associated with previous payments.

At block 310, a next biller-specified condition may be selected for processing. A determination may then be made at block 315 as to whether the selected biller-specified condition has been satisfied. As set forth above, a wide variety of different types of biller-specified conditions may be evaluated, such as timing and/or payment timing and/or volume conditions, payment amount conditions, and/or payment status conditions.

An example payment timing and/or volume condition may be a condition that evaluates whether a minimum number of past payments, optionally to be received within a predetermined period of time (e.g., the previous three months, the previous six months, the previous year, etc.) have been received. Another example payment timing and/or volume condition may evaluate whether a threshold period of elapsed time has occurred since a last payment. Another example payment timing and/or volume condition may evaluate whether a biller-specified threshold period of time between payments has been satisfied (e.g., an average frequency of payment).

As desired, payment timing and/or volume conditions may be utilized to extract relevant payment history information from one or more suitable data repositories. Alternatively, payment history information associated with prior payments made by the payor to the biller may be sorted based at least in part upon any number of relevant time periods associated with the biller-specified payment timing and/or volume conditions. In this regard, any number of other biller-specified conditions (e.g., amount conditions, status conditions, etc.) may be evaluated utilizing relevant payment history information that has been determined to satisfy one or more timing and/or volume conditions.

A wide variety of different amount conditions may also be utilized as desired in various embodiments of the invention. For example, amount conditions may include, but are not limited to, a minimum payment amount associated with one or more past payments made by the payor to the biller, a minimum total payment amount associated with one or more past payments, an average payment amount associated with one or more past payments, and/or amounts incurred for unsuccessful payments (e.g., check bouncing fees, etc.).

Additionally, a wide variety of different status conditions may be utilized as desired in various embodiments of the invention. For example, status conditions may include, but are not limited to, a threshold number of past payments that were successfully effected or posted, a threshold percentage of past payments that were successfully effected or posted, a threshold number of past payments that were not successfully effected or posted, a threshold percentage of past payments that were not successfully effected or posted, a threshold number of past payments that were reversed, and/or a threshold percentage of past payments that were reversed.

If it is determined at block 315 that the selected condition has not been satisfied, then operations may continue at block 320. At block 320, a determination may be made that the identified biller-specified conditions have not been satisfied. Accordingly, a determination may be made that electronic bill presentment will not be activated for the payor. If, however, it is determined at block 315 that the selected biller-specified condition has been satisfied, then operations may continue at block 325.

At block 325, a determination may be made as to whether the end of the identified biller-specified conditions has been reached. If it is determined at block 325 that the end of the conditions has not been reached, then operations may continue at block 310, and a next biller-specified condition may be selected for evaluation. If, however, it is determined at block 325 that the end of the conditions has been reached, then operations may continue at block 330. At block 330, a determination may be made that all of the relevant biller-specified conditions have been satisfied.

The method 300 may end following either block 325 or 340.

Although the method 300 illustrated in FIG. 3 describes the evaluation of biller-specified conditions, one or more conditions associated with other entities may be evaluated as desired in various embodiments of the invention. For example, one or more payor-specified conditions, service provider-specified conditions, and/or financial institution-specified conditions may be evaluated in a similar manner as that described above with respect to FIG. 3.

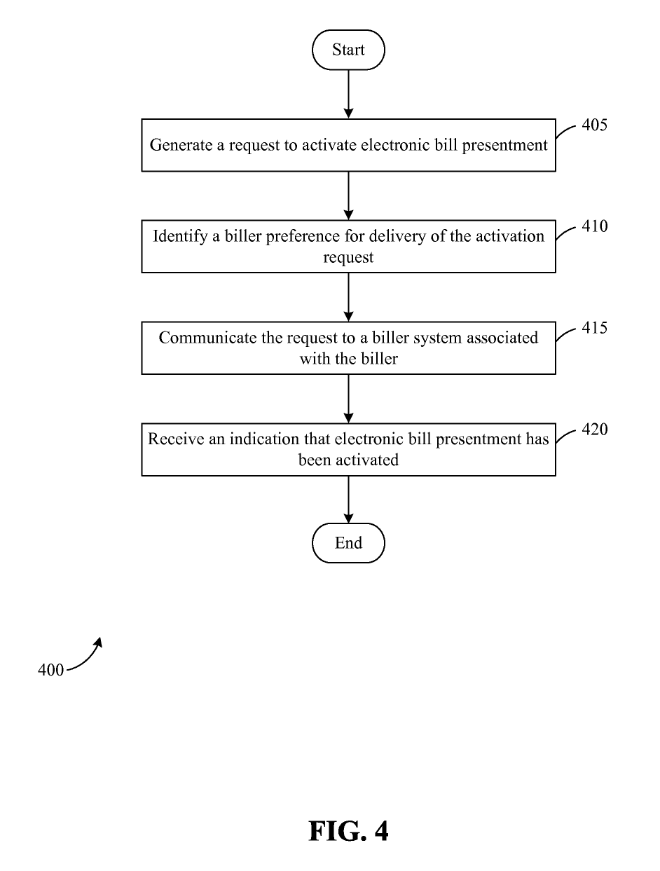

FIG. 4 is a flow diagram of an example method 400 for automatically activating electronic bill presentment, according to an example embodiment of the invention. The operations included in the method 400 may be one example of the operations performed at block 235 of the method 200 illustrated in FIG. 2. As such, the operations of the method 400 may be performed by one or more service provider computers associated with a service provider, such as the service provider computers 120 associated with the service provider system 105 of FIG. 1. The method 400 may begin at block 405.

At block 405, a request to activate electronic bill presentment may be generated. For example, following a determination by a service provider system 105 that one or more conditions associated with the automatic activation of electronic presentment of bills of a biller to a payor have been satisfied, the service provider system 105 may generate a request to activate the electronic presentment of bills of the biller to the payor. A wide variety of information may be included in the generated request as desired in various embodiments of the invention, such as identification information for the payor, identification information for the service provider, information associated with an account of the payor with the biller (e.g., an account number), information associated with the evaluation of payment history information, information associated with the evaluation of biller-specified parameters, and/or a request to activate electronic bill presentment for the payor.

At block 410, a biller preference for the delivery of the generated activation request may be identified. In other words, a desired method or process for communicating the generated activation request to the biller may be identified or determined. A wide variety of suitable methods and/or techniques may be utilized as desired to communicate the activation request to a biller system 110 associated with the biller. Examples of suitable communication methods include, but are not limited to, an asynchronous batch delivery process, an asynchronous message queue posting process, and/or a wide variety of suitable synchronous communication techniques, such as a Web service request or an Application Programming Interface (“API”) request. In certain synchronous communication techniques, a request may be communicated in real-time or near real-time following a determination that electronic bill presentment should be requested. In certain embodiments, the method utilized to communicate the activation request may be determined based upon the connectivity with the biller system 110.

Additionally, with certain communication techniques (e.g., real-time or near real-time techniques, etc.), one or more parameters associated with the timing of the activation requests may be evaluated. For example, a biller may establish a threshold associated with maximum number of requests that may be processed within a predetermined period of time (e.g., a day, a month, etc.). A determination may be made as to whether the threshold has been reached prior to the delivery of a generated activation request. In the event that the threshold has been reached, the generated activation request may be stored for delivery at a subsequent point in time. In this regard, the biller will not be overwhelmed with requests to be processed.

Once a suitable delivery method is identified at block 410, operations may continue at block 415. At block 415, the identified delivery method may be utilized to communicate the generated request to the biller system 110. As desired, the generated request may be combined with electronic presentment activation requests for any number of other payors, and the combined requests may be communicated to the biller system 110 in a batch process. Alternatively, an individual request may be communicated for a payor. Operations may then continue at block 420.

At block 420, an indication that electronic bill presentment has been activated for the payor may be received. For example, an indication may be received from a biller system 110.

The method 400 may end following block 420.

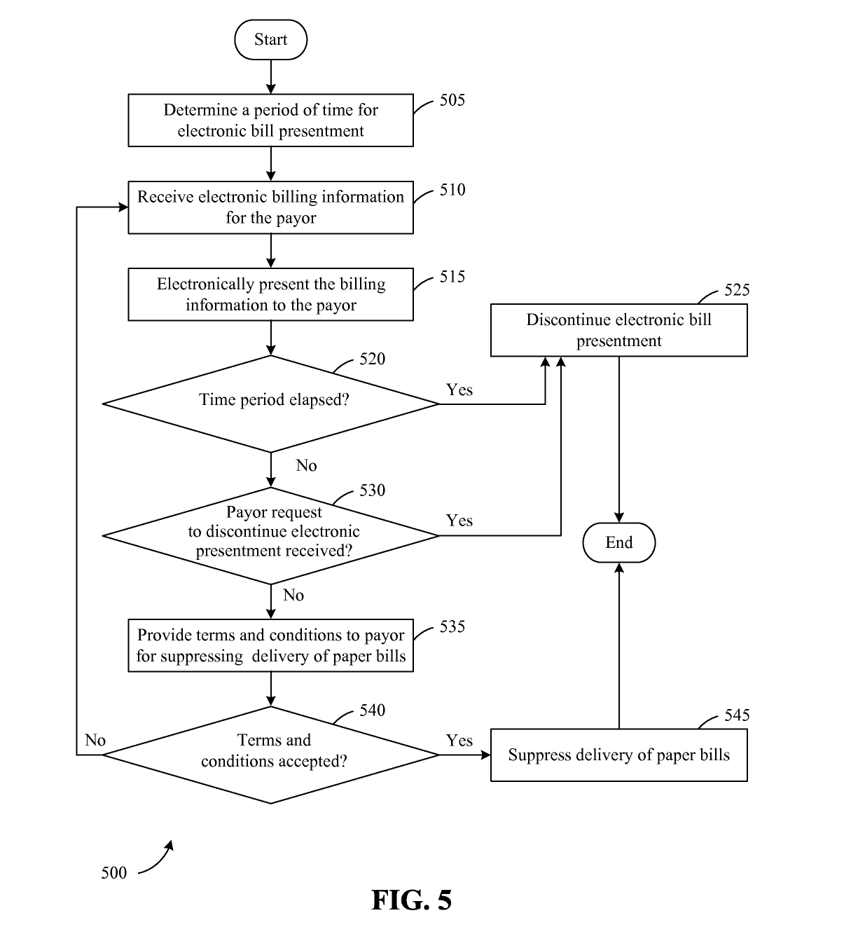

FIG. 5 is a flow diagram of an example method 500 for managing electronic bill presentment, according to an example embodiment of the invention. The operations included in the method 500 may be one example of the operations performed at block 240 of the method 200 illustrated in FIG. 2. As such, the operations of the method 500 may be performed by one or more service provider computers associated with a service provider, such as the service provider computers 120 associated with the service provider system 105 of FIG. 1. The method 500 may begin at block 505.

At block 505, a period of time for electronic presentment of bills of the biller to the payor may be determined. In certain embodiments, the electronic presentment of bills may be activated for a trial period of time, such as one month, three months, six months, etc. As desired, the length of the trial period may be determined based upon a wide variety of biller preferences, payor or consumer preferences, and/or preferences of other entities. In certain embodiments, a biller-specified trial period may be included in the received indication. As desired, both paper and electronic bills may be provided to the payor during the trial period.

During the trial period, electronic billing information for the payor may be provided to the payor. For example, at block 510, electronic billing information for the payor may be received from a biller system 110 or other source. The billing information may include a wide variety of different data, such as a copy of a bill for the payor and/or bill summary information for the payor. Billing information may be received in a wide variety of different formats as desired in various embodiments of the invention. For example, an image or complete copy of a bill may be received. As another example, structured billing information may be received, and the structured billing information may be combined with one or more templates at the service provider prior to bill presentment. As yet another example, a link (e.g., a hyperlink, etc.) to billing information hosted at a biller site may be received. As desired, at least a portion of the received information may be stored for subsequent access and/or presentation to the payor. Additionally, as desired, a notification may be communicated to a payor indicating that billing information is available for electronic presentment.

At block 515, at least a portion of the received billing information may be electronically delivered and/or presented to the payor. For example, at least a portion of the billing information may be formatted by a service provider system, and the formatted information may be communicated to a payor device utilizing a wide variety of suitable methods and/or techniques. Examples of suitable communication methods include Web page presentation, email, short message service (“SMS”) messaging, and/or any other suitable forms of electronic communication.

At block 520, a determination may be made as to whether the period of time for electronic presentment of bills has elapsed. For example, a determination may be made as to whether a trial period has ended. If it is determined at block 520 that the period of time has elapsed, then operations may continue at block 525, and the electronic presentment of bills of the biller to the payor may be discontinued. In certain embodiments, a message may be communicated to a biller system 110 indicating that electronic presentment for the payor should be deactivated. Operations may then end.

If, however, it is determined at block 520 that the period of time has not elapsed, then operations may continue at block 530. At block 530, a determination may be made as to whether a payor request to discontinue electronic bill presentment has been received. In other words, a determination may be made as to whether the payor has chosen to opt out of electronic bill presentment of bills of the biller. A payor request may be received via a wide variety of suitable communication messages, such as Web page selection, email, SMS messaging, interactive voice response (“IVR”) selection, etc. If it is determined at block 530 that a payor request to discontinue electronic bill presentment has been received, then operations may continue at block 520, and electronic bill presentment may be discontinued. If, however, it is determined at block 530 that a payor request to discontinue electronic bill presentment has not been received, then operations may continue at block 535.

At block 535, terms and conditions associated with the suppression of the delivery of paper bills from the biller may be provided to the payor. For example, terms and conditions may be provided via one or more suitable Web pages, via email, and/or via any other suitable communications channel. At block 540, a determination may be made as to whether the terms and conditions have been accepted by the payor. For example, a determination may be made as to whether the payor has requested to extend the trial period permanently and/or whether the payor has requested the suppression of paper bill delivery. In response to either type of request, terms and conditions may be presented to the payor for approval. If it is determined at block 540 that the terms and conditions have not been accepted by the payor, then operations may continue at block 510 described above. If, however, it is determined at block 540 that the terms and conditions have been accepted, then operations may continue at block 545. At block 545, the delivery of paper bills from the biller to the payor may be suppressed. For example, a request may be communicated to a biller system 110 indicating that paper billing should be suppressed, and the biller system 110 may direct the suppression. Following the suppression of paper bill delivery, the electronic presentment of bills may be continued, and a trial period may be ended.

The method 500 may end following either block 520 or block 545.

The operations described and shown in the methods 200, 300, 400, 500 of FIGS. 2-5 may be carried out or performed in any suitable order as desired in various embodiments of the invention. Additionally, in certain embodiments, at least a portion of the operations may be carried out in parallel. Furthermore, in certain embodiments, less than or more than the operations described in FIGS. 2-5 may be performed.

The invention is described above with reference to block and flow diagrams of systems, methods, apparatuses, and/or computer program products according to example embodiments of the invention. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams may not necessarily need to be performed in the order presented, or may not necessarily need to be performed at all, according to some embodiments of the invention.

These computer-executable program instructions may be loaded onto a general-purpose computer, a special-purpose computer, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable memory that can direct a computer or other programmable data processing apparatus to function in a particular manner, such that the instructions stored in the computer-readable memory produce an article of manufacture including instruction means that implement one or more functions specified in the flow diagram block or blocks. As an example, embodiments of the invention may provide for a computer program product, comprising a computer usable medium having a computer-readable program code or program instructions embodied therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions, and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements or steps, or combinations of special-purpose hardware and computer instructions.

Many modifications and other embodiments of the invention will come to mind to one skilled in the art to which this invention pertains and having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

The claimed invention is:

1. A method, comprising:
identifying, by a computerized electronic bill presentment and payment system comprising one or more computers, payment history information associated with one or more payments made on behalf of a payor to a biller;
identifying, by the computerized electronic bill presentment and payment system, at least one biller-specified condition associated with automatic activation of electronic presentment of bills of the biller for the payor;
determining, by the electronic bill presentment and payment system and based at least in part on the identification of the biller-specified condition and upon an analysis of the identified payment history information, that the at least one biller-specified condition associated with automatic activation of electronic presentment of bills of the biller for the payor has been satisfied; and
facilitating, by the computerized electronic bill presentment and payment system and based at least in part upon the determination that the at least one biller-specified condition is satisfied, the automatic activation of the electronic presentment of bills of the biller for the payor without receiving a payor-initiated request to activate the electronic presentment of bills,
wherein facilitating the automatic activation of the electronic presentment of bills comprises transmitting, by the computerized electronic bill presentment and payment system to a biller computer associated with the biller, via a network interface, an activation request on behalf of the payor.

2. The method of claim 1, wherein identifying payment history information comprises at least one of (i) identifying information associated with one or more payments made to the biller by a service provider on behalf of the payor or (ii) identifying information associated with one or more payments made directly to the biller by the payor.

3. The method of claim 1, further comprising:
receiving, by the computerized electronic bill presentment and payment system from the biller computer in response to the activation request, via the network interface, an indication that the electronic presentment of bills has been activated for the payor.

4. The method of claim 1, wherein facilitating the automatic activation of the electronic presentment of bills comprises facilitating the automatic activation for a predetermined period of time.

5. The method of claim 4, wherein the network interface is a first network interface, and further comprising:
receiving, by the computerized electronic bill presentment and payment system during the predetermined period of time, via a second network interface, a payor request to opt out of the electronic presentment of bills; and
facilitating, by the computerized electronic bill presentment and payment system responsive to the received request, the termination of the electronic presentment of bills.

6. The method of claim 1, further comprising:
facilitating, by the computerized electronic bill presentment and payment system, suppression of the delivery of paper billing statements to the payor by the biller.

7. The method of claim 6, wherein the network interface is a first network interface, and further comprising:
transmitting, by the computerized electronic bill presentment and payment system for presentation to a payor, via a second network interface, terms and conditions associated with the suppression of the delivery of paper billing statements; and
receiving, by the computerized electronic bill presentment and payment system on behalf of the payor, via the second network interface, a payor acceptance of the terms and conditions,
wherein facilitating suppression of the delivery of paper billing statements comprises facilitating suppression based at least in part upon receiving the payor acceptance.

8. The method of claim 1, wherein identifying at least one biller-specified condition comprises identifying at least one of (i) a minimum payment amount associated with one or more respective past payments, (ii) a minimum total payment amount associated with one or more past payments, (iii) a minimum number of past payments, (iv) a minimum number of past payments within a predetermined period of time, (v) a minimum number of past successfully effected or posted payments, or (vi) a minimum percentage of past successfully effected or posted payments.

9. The method of claim 1, further comprising:
identifying, by the computerized electronic bill presentment and payment system, an automatic activation condition associated with at least one of (i) the payor or (ii) a financial institution of the payor; and
determining, by the system, that the automatic activation condition has been satisfied,
wherein facilitating automatic activation of the electronic presentment of bills comprises facilitating automatic activation based at least in part upon determining that the automatic activation condition has been satisfied.

10. A system, comprising:
at least one memory operable to store computer-executable instructions; and
at least one processor configured to access the at least one memory and execute the computer-executable instructions to:
identify payment history information associated with one or more payments made on behalf of a payor to a biller;
identify at least one biller-specified condition associated with automatic activation of electronic presentment of bills of the biller for the payor;
determine, based at least in part upon the identification of the biller-specified condition and upon an analysis of the identified payment history information, that the at least one biller-specified condition associated with automatic activation of electronic presentment of bills of the biller for the payor has been satisfied; and
facilitate, based at least in part upon the determination that the at least one biller-specified condition is satisfied, the automatic activation of the electronic presentment of bills of the biller for the payor without receiving a payor-initiated request to activate the electronic presentment of bills,
wherein the facilitation of the automatic activation of the electronic presentment of bills comprises the at least one processor further configured to execute the computer-executable instructions to direct communication, to a biller computer associated with the biller, of an activation request on behalf of the payor.

11. The system of claim 10, wherein the payment history information comprises at least one of (i) information associated with one or more payments made to the biller by a service provider on behalf of the payor or (ii) information associated with one or more payments made directly to the biller by the payor.

12. The system of claim 10, wherein the at least one processor is further configured to execute the computer-executable instructions to:
receive, from the biller computer in response to the activation request, an indication that
electronic presentment of bills has been activated for the payor.

13. The system of claim 10, wherein the electronic presentment of bills is automatically activated for a predetermined period of time.

14. The system of claim 13, wherein the at least one processor is further configured to execute the computer-executable instructions to:
receive, during the predetermined period of time, a payor request to opt out of the electronic presentment of bills; and
facilitate, responsive to the received request, the termination of the electronic presentment of bills.

15. The system of claim 10, wherein the at least one processor is further configured to execute the computer-executable instructions to:
facilitate suppression of the delivery of paper billing statements to the payor by the biller.

16. The system of claim 15, wherein the at least one processor is further configured to execute the computer-executable instructions to:
transmit, for presentation to a payor, of terms and conditions associated with the suppression of the delivery of paper billing statements;
receive, on behalf of the payor, a payor acceptance of the terms and conditions; and
facilitate suppression of the delivery of paper billing statements based at least in part upon receiving the payor acceptance.

17. The system of claim 10, wherein the at least one biller-specified condition comprises at least one of (i) a minimum payment amount associated with one or more respective past payments, (ii) a minimum total payment amount associated with one or more past payments, (iii) a minimum number of past payments, (iv) a minimum number of past payments within a predetermined period of time, (v) a minimum number of past successfully effected or posted payments, or (vi) a minimum percentage of past successfully effected or posted payments.

18. The system of claim 10, wherein the at least one processor is further configured to execute the computer-executable instructions to:
identify an automatic activation condition associated with at least one of (i) the payor or (ii) a financial institution of the payor;
determine that the automatic activation condition has been satisfied; and
facilitate the automatic activation of the electronic presentment of bills based at least in part upon determining that the automatic activation condition has been satisfied.
